(19) United States
(12) Patent Application Publication
(10) Pub. No.: US 2003/0214713 A1
(43) Pub. Date: Nov. 20, 2003

(54) Method and device to calculate and display the transformation of optical polarization states

(76) Inventors: Edward Collett, Lincroft, NJ (US); Joseph D. Evankow JR., Colts Neck, NJ (US); Van E. Kelly, Bernardsville, NJ (US)

Correspondence Address: MICHAELSON AND WALLACE, PARKWAY 109 OFFICE CENTER, 328 NEWMAN SPRINGS RD, P O BOX 8489, RED BANK, NJ, 07701

(21) Appl. No.: 10/324,188

(22) Filed: Dec. 20, 2002

Related U.S. Application Data
(60) Provisional application No. 60/343,268, filed on Dec. 21, 2001.

(51) Int. Cl. G02B 27/28

(52) U.S. Cl. 359/483

(57) ABSTRACT

We have invented a set of calculation and display methods for polarized light using a representation that we call the Hybrid Polarization Sphere (HPS). The HPS incorporates the Poincaré Sphere and its dual, the Observable Polarization Sphere (OPS). The HPS uses a four-pole spherical polar coordinate system to map the transformation of the state(s) of polarization (SOP) of a beam of light as the beam propagates through one or more polarizing elements (polarizer, waveplate, or rotator). A simple computing aid based on the HPS leads to methods for solving optical polarization problems directly by visual measurement and interpolation. These avoid both the linear algebra and trigonometry of the underlying mathematics and the external apparatus needed to use the Poincaré Sphere for computing phase shifts. Furthermore, simulating and animating these methods on an electronic graphical display produces helpful visual explanations of numerical solutions to polarization problems.

### CLAIM TO PRIORITY

This application claims the benefit of our co-pending United States provisional patent application entitled “Method and Device to Calculate and Display the Transformation of Optical Polarization States” filed Dec. 21, 2001 and assigned serial No. 60/343,268, which is incorporated by reference herein.

### FIELD OF THE INVENTION

The invention relates to methods of using a representation called the Hybrid Polarization Sphere for calculating and displaying the polarization state of an optical beam as the beam propagates through polarizing elements (waveplates, polarizers, and rotators).

### BACKGROUND

Polarization is one of the fundamental properties of electromagnetic radiation. Numerous investigations over the past two hundred years have sought to understand and control the state of polarization (SOP) of optical beams. This has led to dozens of applications of polarized light such as the measurement of the refractive index of optical materials, saccharimetry, ellipsometry, fluorescence polarization, etc., to name only a few. In recent years, fiber optic communications has led to new discoveries on the behavior of polarized beams propagating in fibers. Bit rates at and above 10 Gbs manifest polarization-related signal degradation caused by the birefringence of the fiber optic transmission medium. In order to mitigate these effects, it is important to measure, model, and display the SOP of the optical beam.

There are several standard methods for modeling the SOP of a polarized optical beam. One of the most useful is a polarimetric method known as the Poincaré Sphere (PS) method. This method is particularly valuable because it provides a quantitative visualization of the behavior of polarized light propagating through an optical fiber or optical polarizing devices.

Henri Poincaré, a French mathematician, suggested the Poincaré Sphere in the late 19th century, based on an analogy with the terrestrial (or celestial) sphere. He proposed it as a visualization tool and a calculating aid to describe the SOP of a polarized beam propagating through polarizing elements. One can readily determine the shortest travel distance between two cities, e.g., London and New York either by using the equations of spherical trigonometry (difficult) or by directly measuring the length of a piece of string stretched taut between those two locations on a terrestrial globe (easy). Poincaré conceived that SOP transformations performed by optical devices could be similarly done on the Poincaré Sphere.

Poincaré was motivated by the near-intractability of direct calculations of SOP transformations using the mathematics of his day. Nevertheless, the hoped-for simplicity using the Poincaré sphere did not occur. It was an excellent visualization tool but most practical calculations using the sphere were still extremely difficult to do. Poincaré did not take into account that no single conventional spherical polar coordinate system could simplify polarization calculations.

The computation problems for polarized light were first solved in the late 1940s with the introduction of the algebraic methods of the Jones and Mueller/Stokes calculi. These parametric calculi, however, did not directly enable simple visualizations of polarized light interactions. Thus, they did not fulfill Poincaré's goal of a device that would allow both visualization and calculation to be made in the same space without having to resort to complex algebraic and trigonometric calculations. Modern digital computers have automated the Jones/Mueller/Stokes computations, but this still does not provide a simple geometric view of how polarization works.

Remarkably, a consistent mathematical treatment of the Poincaré sphere did not appear until H. Jerrard's analysis in 1954, which provided some important clues about the Poincaré's formulation. Jerrard wrote down the first formal algorithms for using the Poincaré sphere as a computing device, and constructed a physical model to verify the usability of these algorithms. He mounted a globe in a gimbal with protractor markings, so that it could be rotated with precision around both a north-south and an east-west axis. During computation, a reference point fixed in space just above the surface of the sphere tracked the state of polarization (e.g., a crosshair projected on the surface from a fixed projector), while the sphere was rotated underneath. The computational accuracy thus depended on mechanical stability and eccentricity. To our knowledge, Jerrard's implementation never came into use as a computational aid. Our analysis of its mechanical and operational complexity led back to Poincaré's original polar coordinate system, which is optimally oriented for carrying out calculations involving rotational elements (polarizing rotators such as quartz rotators) but is not oriented for modeling phase shifting elements (waveplates).

Because of this limitation on phase shifting, we developed a new polarization sphere, which we call the Observable Polarization Sphere (OPS). This sphere also uses a spherical polar coordinate system that, as it turns out, is optimally oriented for solving problems involving phase shifting elements (waveplates). However, it is not particularly well suited for treating rotation problems. Thus, the behavior of the OPS is a mathematical dual of the Poincaré Sphere, and its applicability faces similar complications. Independently, other researchers, most notably Jerrard in 1982, Collett in 1992, and Huard in 1997, investigated similar angular representations of the Stokes parameters, but passed them over as having no apparent improvement over the Poincaré Sphere.

To combine the rotational strength of the Poincaré Sphere and the phase shifting strength of the Observable Polarization Sphere, we have superimposed the coordinate systems for both spheres, forming another representation, which we call the Hybrid Polarization Sphere (HPS). The HPS is a four-pole sphere having two orthogonal axes. This simplifies the complex system of gimbals, protractors, and fixed points needed with Jerrard's implementation of the Poincaré sphere; all the computing apparatus lies on the surface of the sphere itself. Instead of rotating a physical globe, one simply traverses lines on its surface. This means that the HPS can be realized as a flat map projection, with major advantages in both convenience and accuracy. The most flexible realization, however, uses an electronic display.

Using the HPS, we have developed algorithms that are simpler than Jerrard's for calculating and displaying the SOP of any electromagnetic beam propagating through waveplates, rotators, and ideal linear polarizers.

### SUMMARY OF THE INVENTION

The present invention provides a method whereby a practitioner can visualize and calculate the polarization behavior of an optical beam as it propagates through an optical fiber system (or bulk optical system). This calculation can be done by visual interpolation using ordinary map-reading skills, and without the aid of a computer or other external calculation aid. The invention is based on a sphere, called the Hybrid Polarization Sphere, which is a superposition of the Poincaré Sphere and the Observable Polarization Sphere in mutually orthogonal orientations, consistent with the Stokes basis vectors. All polarization computations are reduced to sequences of simple angular displacements along small circle latitude lines (phase shifts) and small circle longitude lines (rotations) on the HPS. Since both coordinate systems (the Poincaré Sphere and the Observable Polarization Sphere) are superimposed, elaborate mechanical contrivances previously needed to calculate within the single polar coordinate system of the Poincaré Sphere are unnecessary.

While a geometric model of a mathematical domain is not patentable in itself, such models give rise to useful analog computing devices and methods, such as the terrestrial globe, the slide rule, and the nomograph. Even in the age of high-speed digital computers, some of these devices (e.g., the terrestrial and celestial globes) and their methods survive in simulated form. This is done not because they are essential for finding numerical solutions, but because their visual presentation remains a natural frame of reference for humans to better understand, validate, and extend those solutions. Such is the case with the methods we have invented for utilizing the HPS.

We enumerate three embodiments of the invention: using a three-dimensional globe, using two-dimensional spherical plots, and using an electronic display. The electronic embodiment is preferred. Even though computer automation of the Jones and Mueller/Stokes calculi has reduced the need for an analog computation aid, the ability to display the numerical solutions in terms of a simple geometric means will help practitioners to understand the behavior of polarized light as it propagates through a polarizing system.

The implementation of the HPS is simplified by the fact that both the Poincaré Sphere and the OPS assume a right-handed coordinate system with respect to the three Stokes polarization parameters that serve as the basis vectors of the underlying Euclidean 3-space. This ensures that the physical interpretation of clockwise vs. counter-clockwise rotation is completely consistent among the three constructs. All that is required to create the HPS is to rotate the Poincaré spherical polar coordinate system 90° clockwise relative to an OPS coordinate system.

Because the HPS superposes two complete spherical polar coordinate systems, it is a four-pole sphere. Based on the concepts of observables in optics, we elect to designate the prime axis of the OPS as the north-south (vertical) axis of the HPS, and the Poincaré prime axis becomes the east-west (horizontal) axis of the HPS. This choice has the advantage that it is directly connected to the optical apparatus used to measure polarized light.

The following table summarizes the physical interpretation of the four-pole coordinate system of the HPS in terms of fundamental properties of the polarization ellipse (Collett, 1992).

| | Moving Along | Moving Along |
|---|---|---|
| Coordinate | Longitudinal | Latitudinal |
| System | Great Circles | Small Circles |
| Poincaré | changing chi (χ): | changing psi (ψ): |
| | ellipticity angle | rotation angle |
| OPS | changing alpha (α): | changing delta (δ): |
| | arctangent of | phase angle |
| | orthogonal amplitude | |
| | ratio | |

With regard to the methods of the invention itself, calculating the behavior of an optical system begins with determining the location of an input State of Polarization (SOP) on the HPS using either Poincaré or OPS coordinates. The SOP transformations are then modeled as sequences of rotation and phase shift operations starting from the initial input SOP, according to the following rules:

Field rotations using polarizing rotators are calculated by measuring out angular displacements (θ) along longitudinal small circles (ψ) of the HPS. Counter-clockwise displacements represent positive rotator angles.

Phase shifts are calculated by measuring out angular displacements (φ) along latitudinal small circles (δ) on the HPS. Counter-clockwise displacements represent phase lead and clockwise displacements represent phase lag.

Attenuation by a rotated linear polarizer is represented by a discontinuous jump to the north pole of the HPS, followed by performing the action of rotation.

By concatenating a sequence of angular displacements, the polarization behavior of any sequence of waveplates, rotators, and polarizers upon a beam of polarized light may be calculated. The point on the HPS that is the result after all the displacements have been measured represents the final SOP for the beam emerging from the optical system.

The properties represented by psi (ψ) and delta (δ) are fundamental to high-speed fiber optic transmission systems. On the other hand, chi (χ) and alpha (α) do not represent distinct physical properties of interest in polarization measurements. When solving polarization problems on the HPS it is never necessary to traverse longitudinal or latitudinal great circles.

### Mathematical Development of the Hybrid Polarization Sphere

In order to understand the Hybrid Polarization Sphere and its operation, it is necessary to understand its mathematical foundations. This is done by first describing the mathematics of the Poincaré Sphere followed by the mathematics of the Observable Polarization Sphere. In both cases the Mueller matrices for the rotation, phase shifting, and attenuation of a polarized beam are required.

Two formulations of polarized light exist. The first is in terms of the amplitudes and absolute phases of the orthogonal components of the optical field. In the amplitude representation the orthogonal (polarization) components are represented by

Eₓ(z,t)=E₀ₓ cos(ωt−kz+δₓ) (1a)

E_{y}(z,t)=E_{0y} cos(ωt−kz+δ_{y}) (1b)

Eq. (1) describes two orthogonal waves propagating in the z-direction at a time t. In particular, in eq. (1), E₀ₓ and E_{0y} are the peak amplitudes, ωt−kz is the propagator and describes the propagation of the wave in time and space, and δₓ and δ_{y} are the absolute phases of the wave components.

Eq. (1) is an instantaneous representation of the optical field and, in general, cannot be observed nor measured because of the short time duration of a single oscillation, which is of the order of 10⁻¹⁵ seconds. However, if the propagator is eliminated between eq. (1a) and eq. (1b) then a representation of the optical field can be found that describes the locus of the combined amplitudes Eₓ(z,t) and E_{y}(z,t). Upon doing this one is led to the following equation:

$$\frac{{{E}_{x} ( z , t )}^{2}}{{E}_{0 x}^{2}} + \frac{{{E}_{y} ( z , t )}^{2}}{{E}_{0 y}^{2}} - \frac{2 {E}_{x} ( z , t ) {{E}_{y} ( z , t )}^{2}}{{E}_{0 x} {E}_{0 y}} cos δ = {sin}^{2} δ \qquad ( 2 )$$

where δ=δ_{y}−δₓ. Eq. (2) is the equation of an ellipse in its non-standard form and is known as the polarization ellipse. Thus, the locus of the polarized field describes an ellipse as the field components represented by eq. (1) propagate. For special values of E₀ₓ, E_{0y}, and δ, eq. (2) degenerates to the equations for a straight line and circles; this behavior leads to the optical polarization terms linearly polarized light and circularly polarized light.

Eq. (2) like eq. (1) can neither be observed nor measured. However, the observed form of eq. (2) can be found by taking a time average. When this is done, eq. (2) is transformed to the following equation (Collett, 1968, 1992):

S₀²=S₁²+S₂²+S₃² (3a)

where

S₀=E₀ₓ²+E_{0y}² (3b)

S₁=E₀ₓ²−E_{0y}² (3c)

S₂=2E₀ₓE_{0y} cos δ (3d)

S₃=2E₀ₓE_{0y} sin δ (3e)

Eq. (3b) through eq. (3e) are known as the Stokes polarization parameters, which are the observable (measurables) of the polarization of the optical field because they are all intensities. In order to determine the polarization of the optical field all four Stokes polarization parameters must be measured. The first Stokes parameter S₀, is the total intensity of the optical beam. The remaining three parameters, S₁, S₂, and S₃ describe the (intensity) polarization state of the optical beam. The parameter S₁ describes the preponderance of linearly horizontal polarized light over linearly vertical polarized light, the parameter S₂ describes the preponderance of linearly +45° polarized light over linearly −45° polarized light, and finally the parameter S₃ describes the preponderance of right-circularly polarized light over left-circularly polarized light, respectively. The Stokes parameters, eq. (3), can be written as a column matrix known as the Stokes vector,

$$S = ( \begin{matrix}{S}_{0} \\ {S}_{1} \\ {S}_{2} \\ {S}_{3}\end{matrix} ) = ( \begin{matrix}{E}_{0 x}^{2} + {E}_{0 y}^{2} \\ {E}_{0 x}^{2} - {E}_{0 y}^{2} \\ 2 {E}_{0 x} {E}_{0 y} cos δ \\ 2 {E}_{0 x} {E}_{0 y} sin δ\end{matrix} ) \qquad ( 4 )$$

Eq. (4) describes elliptically polarized light. However, for special conditions on E₀ₓ, E_{0y}, δ, eq. (4) reduces to the important degenerate forms for 1) linearly horizontal and linear vertical polarized light, 2) linear +45° and linear −45° polarized light, and 3) right- and left-circularly polarized light. The Stokes vectors for these states in their normalized form (S₀=1) are:

$${S}_{LHP} = ( \begin{matrix}1 \\ 1 \\ 0 \\ 0\end{matrix} ) {S}_{LVP} = ( \begin{matrix}1 \\ - 1 \\ 0 \\ 0\end{matrix} ) {S}_{L + 45 P} = ( \begin{matrix}1 \\ 0 \\ 1 \\ 0\end{matrix} ) {S}_{L - 45 P} = ( \begin{matrix}1 \\ 0 \\ - 1 \\ 0\end{matrix} ) {S}_{RCP} = ( \begin{matrix}1 \\ 0 \\ 0 \\ 1\end{matrix} ) {S}_{LCP} = ( \begin{matrix}1 \\ 0 \\ 0 \\ - 1\end{matrix} ) \qquad ( 5 )$$

Finally, a polarized optical beam can be transformed to a new polarization state S′ by using a waveplate, rotator, and/or linear polarizer. This is described by a matrix equation of the form

S′=M·S (6)

where M is a 4×4 matrix known as the Mueller matrix.

The Mueller matrix for a waveplate with its fast axis along the horizontal x-axis and a phase shift of φ is

$${M}_{WP} ( φ ) = ( \begin{matrix}1 & 0 & 0 & 0 \\ 0 & 1 & 0 & 0 \\ 0 & 0 & cos φ & - sin φ \\ 0 & 0 & sin φ & cos φ\end{matrix} ) \qquad ( 7 )$$

Similarly, the Mueller matrix for a rotator (rotated through a positive (counter-clockwise) angle through an angle θ from the horizontal x-axis) is

$${M}_{ROT} ( θ ) = ( \begin{matrix}1 & 0 & 0 & 0 \\ 0 & cos 2 θ & sin 2 θ & 0 \\ 0 & - sin 2 θ & cos 2 θ & 0 \\ 0 & 0 & 0 & 1\end{matrix} ) \qquad ( 8 )$$

Finally, the Mueller matrix for an ideal linear polarizer with its transmission along the horizontal x-axis is

$${M}_{POL} = \frac{1}{2} ( \begin{matrix}1 & 1 & 0 & 0 \\ 1 & 1 & 0 & 0 \\ 0 & 0 & 0 & 0 \\ 0 & 0 & 0 & 0\end{matrix} ) \qquad ( 9 )$$

For rotation of a waveplate or polarizer through an angle, θ, the Mueller matrix is found to transform according to the equation

M(θ)=M_{ROT}(−θ)·M·M_{ROT}(θ) (10)

Straightforward substitution of the Mueller matrices for a waveplate (phase shifter) or polarizer (attenuator), eq. (7) and eq. (9), yields the rotated form. However, as we shall see, it is much more useful to use the form given by eq. (10) to describe the motion of these polarizing elements on the Hybrid Polarization Sphere.

The Poincaré Sphere

The Stokes parameters can also be expressed in terms of the orientation and ellipticity angles, ψ and χ, of the polarization ellipse. In terms of these angles, the Stokes vector is then found to have the form

$$S = ( \begin{matrix}{S}_{0} \\ {S}_{1} \\ {S}_{2} \\ {S}_{3}\end{matrix} ) = ( \begin{matrix}1 \\ cos 2 χcos 2 ψ \\ cos 2 χsin 2 ψ \\ sin 2 χ\end{matrix} ) 0 \leq ψ \leq π , - \frac{π}{4} \leq χ \leq \frac{π}{4} \qquad ( 11 )$$

A sphere can be constructed in which the Cartesian x-, y-, and z-axes are represented in terms of the Stokes parameters S₁, S₂, and S₃, respectively. This spherical representation is known as the Poincaré Sphere and is shown in FIG. 1. The angle ψ is measured from the S₁ axis and the angle χ is measured positively above the equator and negatively below the equator. In particular, the degenerate forms (linear and circularly polarized light) are found as follows. For χ=π/4 and χ=−π/4 eq. (11) becomes

$${S}_{RCP} = ( \begin{matrix}{S}_{0} \\ {S}_{1} \\ {S}_{2} \\ {S}_{3}\end{matrix} ) = ( \begin{matrix}1 \\ 0 \\ 0 \\ 1\end{matrix} ) {S}_{LCP} = ( \begin{matrix}{S}_{0} \\ {S}_{1} \\ {S}_{2} \\ {S}_{3}\end{matrix} ) = ( \begin{matrix}1 \\ 0 \\ 0 \\ - 1\end{matrix} ) \qquad ( 12 )$$

These two Stokes vectors represent right- and left-circularly polarized light and correspond to the north and south poles of the Poincaré Sphere along the positive and negative S₃ axis, respectively. This is emphasized by retaining the notation for the Stokes vector preceding each of the specific Stokes vector in eq. (12).

The equator on the Poincaré Sphere corresponds to χ=0 so eq. (11) reduces to

$${S}_{LP} = ( \begin{matrix}{S}_{0} \\ {S}_{1} \\ {S}_{2} \\ {S}_{3}\end{matrix} ) = ( \begin{matrix}1 \\ cos 2 ψ \\ sin 2 ψ \\ 0\end{matrix} ) \qquad ( 13 )$$

Eq. (13) is the Stokes vector for linearly polarized light. Thus, along the equator all polarization states are linearly polarized. The degenerate forms for linearly polarized light are then found by setting ψ=0, π/4, π/2, and 3π/4, respectively. Eq. (13) then reduces to the following corresponding forms:

$$\begin{matrix} {S}_{LHP} = ( \begin{matrix}{S}_{0} \\ {S}_{1} \\ {S}_{2} \\ {S}_{3}\end{matrix} ) = ( \begin{matrix}1 \\ 1 \\ 0 \\ 0\end{matrix} ) {S}_{L + 45 P} = ( \begin{matrix}{S}_{0} \\ {S}_{1} \\ {S}_{2} \\ {S}_{3}\end{matrix} ) = ( \begin{matrix}1 \\ 0 \\ 1 \\ 0\end{matrix} ) & ( 14 a ) \\ {S}_{LVP} = ( \begin{matrix}{S}_{0} \\ {S}_{1} \\ {S}_{2} \\ {S}_{3}\end{matrix} ) = ( \begin{matrix}1 \\ - 1 \\ 0 \\ 0\end{matrix} ) {S}_{L - 45 P} = ( \begin{matrix}{S}_{0} \\ {S}_{1} \\ {S}_{2} \\ {S}_{3}\end{matrix} ) = ( \begin{matrix}1 \\ 0 \\ - 1 \\ 0\end{matrix} ) & ( 14 b )\end{matrix}$$

Eq. (14a) and eq. (14b) clearly show that linearly horizontal polarized light and linear vertical polarized light are associated with the positive and negative Stokes parameter S₁ and linear +45 polarized light and the linear −45 polarized light are associated with the positive and negative S₂ parameter. This is important to note the construction of the coordinates of the Hybrid Polarization Sphere must be consistent with the Poincaré Sphere and the Observable Polarization Sphere. In FIG. 2, the degenerate polarization states are shown on the Poincaré Sphere.

We now describe an important property of the Poincaré Sphere, namely, its rotational behavior. In order to understand this behavior we consider that an input beam, represented by eq. (11), propagates through a rotator, eq. (8). Then, the Stokes vector of the output beam is

S′=M_{ROT}(θ)·S (15)

and

$${S}^{′} = ( \begin{matrix}{S}_{0}^{′} \\ {S}_{1}^{′} \\ {S}_{2}^{′} \\ {S}_{3}^{′}\end{matrix} ) = ( \begin{matrix}1 & 0 & 0 & 0 \\ 0 & cos 2 θ & sin 2 θ & 0 \\ 0 & - sin 2 θ & cos 2 θ & 0 \\ 0 & 0 & 0 & 1\end{matrix} ) ( \begin{matrix}1 \\ cos 2 χcos 2 ψ \\ cos 2 χsin 2 ψ \\ sin 2 χ \end{matrix} ) \qquad ( 16 )$$

Carrying out the matrix multiplication in eq. (16) leads to

$${S}_{ROT}^{′} = ( \begin{matrix}{S}_{0}^{′} \\ {S}_{1}^{′} \\ {S}_{2}^{′} \\ {S}_{3}^{′}\end{matrix} ) = \cdot ( \begin{matrix}1 \\ cos 2 χcos ( 2 ψ - 2 θ ) \\ cos 2 χsin ( 2 ψ - 2 θ ) \\ sin 2 χ \end{matrix} ) \qquad ( 17 )$$

Thus, the operation of a rotation on the incident beam leads to the Stokes vector of the output beam in which the initial value of ψ is decreased by the rotation angle θ. Furthermore, this means that rotation appears on the small circle latitude lines since χ remains unchanged.

Next, consider that the incident beam propagates through a waveplate represented by eq. (7). We see immediately using eq. (11) that the Stokes vector of the output beam becomes

$${S}_{WP}^{′} = ( \begin{matrix}{S}_{0}^{′} \\ {S}_{1}^{′} \\ {S}_{2}^{′} \\ {S}_{3}^{′}\end{matrix} ) = \cdot ( \begin{matrix}1 \\ cos 2 χcos 2 ψ \\ cos 2 χsin2 ψcos φ - sin 2 χsin φ \\ cos 2 χsin2 ψsin φ + sin 2 χcos φ\end{matrix} ) \qquad ( 18 )$$

We see that there is no trigonometric simplification in the matrix elements when the input beam propagates through a waveplate, unlike that of propagation through a rotator. Thus, rotation is simplified on the Poincaré Sphere but phase shifting is not.

Finally, we consider the propagation of an incident beam, eq. (11), through an ideal linear polarizer represented by the Mueller matrix, eq. (9). We have

S′=M_{POL}·S (19a)

so

$$\begin{matrix}{S}_{POL}^{′} = ( \begin{matrix}{S}_{0}^{′} \\ {S}_{1}^{′} \\ {S}_{2}^{′} \\ {S}_{3}^{′}\end{matrix} ) = \frac{1}{2} ( \begin{matrix}1 & 1 & 0 & 0 \\ 1 & 1 & 0 & 0 \\ 0 & 0 & 0 & 0 \\ 0 & 0 & 0 & 0\end{matrix} ) \cdot ( \begin{matrix}1 \\ cos 2 χcos 2 ψ \\ cos 2 χsin 2 ψ \\ sin 2 χ \end{matrix} ) \\ and & ( 19 b ) \\ {S}_{POL}^{′} = ( \begin{matrix}{S}_{0}^{′} \\ {S}_{1}^{′} \\ {S}_{2}^{′} \\ {S}_{3}^{′}\end{matrix} ) = \frac{1}{2} ( 1 + cos 2 χcos 2 ψ ) ( \begin{matrix}\begin{matrix}1 \\ 1 \\ 0\end{matrix} \\ 0\end{matrix} ) & ( 19 c )\end{matrix}$$

Eq. (19c) is the Stokes vector of linearly horizontal polarized light (see eq. (14a)). This is a very important result and states that regardless of the polarization state of the input beam, when the beam propagates through a linear polarizer the polarization state of the output beam will always be linearly horizontal polarized.

The Observable Polarization Sphere

It is possible to find an alternative representation of the Stokes parameters and show that they can be expressed in terms of a different set of angles, namely, the auxiliary angle α, which is a measure of the intensity ratio of the orthogonal components of the beam, and the phase angle δ (Jerrard, 1982, Collett, 1992, Huard, 1997). The Observable Polarization Sphere derives its name from the fact that the two angles α and δ, are associated with the observables (measurables) of the polarization ellipse. Analysis shows that the Stokes vector then has the form

$$S = ( \begin{matrix}{S}_{0} \\ {S}_{1} \\ {S}_{2} \\ {S}_{3}\end{matrix} ) = ( \begin{matrix}1 \\ cos 2 α \\ sin 2 αcos δ \\ sin 2 αsin δ \end{matrix} ) 0 \leq α \leq π / 2 , 0 \leq δ < 2 π \qquad ( 20 )$$

A sphere can be constructed in which the Cartesian x-, y-, and z-axes are now represented in terms of the Stokes parameters S₂, S₃, and S₁, respectively. The spherical angles of the Observable Polarization Sphere are shown in FIG. 3. The angle α is measured from the vertical S₁ axis and the angle δ is measured along the equator in the S₂−S₃ as shown in FIG. 3. In particular, the degenerate forms (linear and circularly polarized light) are found as follows. For α=π/4 and δ=π/2 and α=π/4 and δ=3π/2 eq. (20) becomes

$${S}_{RCP} = ( \begin{matrix}{S}_{0} \\ {S}_{1} \\ {S}_{2} \\ {S}_{3}\end{matrix} ) = ( \begin{matrix}1 \\ 0 \\ 0 \\ 1\end{matrix} ) {S}_{LCP} = ( \begin{matrix}{S}_{0} \\ {S}_{1} \\ {S}_{2} \\ {S}_{3}\end{matrix} ) = ( \begin{matrix}1 \\ 0 \\ 0 \\ - 1\end{matrix} ) \qquad ( 21 )$$

These two Stokes vectors are located at east and west ends of the equator of the Observable Polarization Sphere, that is, along the positive and negative S₃ axis, respectively. This is emphasized by retaining the notation for the Stokes vector preceding each of the specific Stokes vector in eq. (21).

The prime meridian corresponds to δ=0 and we see that eq. (20) reduces to

$${S}_{LP} = ( \begin{matrix}{S}_{0} \\ {S}_{1} \\ {S}_{2} \\ {S}_{3}\end{matrix} ) = ( \begin{matrix}1 \\ cos 2 α \\ sin 2 α \\ 0\end{matrix} ) \qquad ( 22 )$$

Thus, all polarization states on the prime meridian are linearly polarized. The degenerate states (Stokes vectors) are then found by setting α=0, π/4, π/2, and in eq. (20) α=π/4, δ=π, respectively. Eq. (22) then reduces to the following forms:

$$\begin{matrix}{S}_{LHP} = ( \begin{matrix}{S}_{0} \\ {S}_{1} \\ {S}_{2} \\ {S}_{3}\end{matrix} ) = ( \begin{matrix}1 \\ 1 \\ 0 \\ 0\end{matrix} ) {S}_{L + 45 P} = ( \begin{matrix}{S}_{0} \\ {S}_{1} \\ {S}_{2} \\ {S}_{3}\end{matrix} ) = ( \begin{matrix}1 \\ 0 \\ 1 \\ 0\end{matrix} ) & ( 23 a ) \\ {S}_{LVP} = ( \begin{matrix}{S}_{0} \\ {S}_{1} \\ {S}_{2} \\ {S}_{3}\end{matrix} ) = ( \begin{matrix}1 \\ - 1 \\ 0 \\ 0\end{matrix} ) {S}_{L - 45 P} = ( \begin{matrix}{S}_{0} \\ {S}_{1} \\ {S}_{2} \\ {S}_{3}\end{matrix} ) = ( \begin{matrix}1 \\ 0 \\ - 1 \\ 0\end{matrix} ) & ( 23 b )\end{matrix}$$

Eq. (23a) and eq. (23b) show that linearly horizontal polarized light and linear vertical polarized light are associated with the positive and negative Stokes parameter S₁ and the linear +45 polarized light and the linear −45 polarized light are associated with the positive and negative S₂ parameter.

In FIG. 4, the degenerate polarization states are shown on the Observable Polarization Sphere.

On the equator of the Observable Polarization Sphere (2α=π/2) the Stokes vector, eq. (20), reduces to

$$S = ( \begin{matrix}{S}_{0} \\ {S}_{1} \\ {S}_{2} \\ {S}_{3}\end{matrix} ) = ( \begin{matrix}1 \\ 0 \\ cos δ \\ sin δ\end{matrix} ) 0 \leq δ < 2 π \qquad ( 24 )$$

Eq. (24) is the Stokes vector for the polarization ellipse in standard form. This behavior is preserved on the equator of the Hybrid Polarization Sphere where eq. (24) goes from linearly +45° polarized light (δ=0) to right circularly polarized light (δ=π/2), etc.

We now describe an important property (behavior) of the Stokes vector, eq. (20), on the Observable Polarization Sphere. In order to understand this behavior we again consider an input beam represented by eq. (20) that propagates through a waveplate (phase shifter), eq. (7). Then, the Stokes vector of the output beam is

S′=M_{WP}(φ)·S (25a)

and

$${S}^{′} = ( \begin{matrix}{S}_{0}^{′} \\ {S}_{1}^{′} \\ {S}_{2}^{′} \\ {S}_{3}^{′}\end{matrix} ) = ( \begin{matrix}1 & 0 & 0 & 0 \\ 0 & 1 & 0 & 0 \\ 0 & 0 & cos φ & - sin φ \\ 0 & 0 & sin φ & cos φ\end{matrix} ) \cdot ( \begin{matrix}1 \\ cos 2 α \\ sin 2 αcos δ \\ sin 2 αsinδ\end{matrix} ) \qquad ( 25 b )$$

Carrying out the matrix multiplication in eq. (25b) yields

$${S}_{WP}^{′} = ( \begin{matrix}{S}_{0}^{′} \\ {S}_{1}^{′} \\ {S}_{2}^{′} \\ {S}_{3}^{′}\end{matrix} ) = ( \begin{matrix}1 \\ cos 2 α \\ sin 2 α cos ( δ + φ ) \\ sin 2 α sin ( δ + φ )\end{matrix} ) \qquad ( 26 )$$

Thus, the operation of waveplate on the incident beam is to increase the phase of the initial phase of the beam. This means that on the Observable Polarization Sphere, phase shifts appear on the small circle latitude lines. In addition, the phase shift is positive when moving to the right on both the Observable Polarization Sphere; this behavior is also preserved on the Hybrid Polarization Sphere.

Consider now that the incident beam, eq. (20), propagates through a rotator represented by eq. (8). We see immediately that the output beam is

$${S}_{ROT}^{′} = ( \begin{matrix}{S}_{0}^{′} \\ {S}_{1}^{′} \\ {S}_{2}^{′} \\ {S}_{3}^{′}\end{matrix} ) = ( \begin{matrix}1 \\ cos 2 α cos 2 θ + sin 2 α sin 2 θ cos δ \\ - cos 2 αsin 2 θ + sin 2 α cos 2 θ cos δ \\ sin 2 α sin δ\end{matrix} ) \qquad ( 27 )$$

Eq. (27) shows that there is no trigonometric simplification in the matrix elements when the input beam propagates through a rotator. Thus, phase shifting is simplified on the Observable Polarization Sphere but rotation is not and we see that the Poincare' Sphere and the Observable Polarization Sphere behave in opposite manners for rotation and for phase shifting.

Finally, we again consider the propagation of an incident beam represented by eq. (20) through an ideal linear polarizer represented by the Mueller matrix, eq. (9). We then see that

S′=M_{POL}·S (28a)

$${S}_{POL}^{′} = ( \begin{matrix}{S}_{0}^{′} \\ {S}_{1}^{′} \\ {S}_{2}^{′} \\ {S}_{3}^{′}\end{matrix} ) = \frac{1}{2} ( 1 + cos 2 α ) ( \begin{matrix}1 \\ 1 \\ 0 \\ 0\end{matrix} ) \qquad ( 28 b )$$

We again obtain a Stokes vector that is linearly horizontal polarized. Thus, in both the Poincare' Sphere and Observable Polarization Sphere formulations the linear polarizer operation is identical.

We also consider the case where the ideal linear polarizer is rotated through an angle θ. The Mueller matrix for a rotated ideal linear polarizer is

M_{POL}(θ)=M_{ROT}(−θ)·M_{POL}·M_{ROT}(θ) (29)

where M_{ROT}(θ) and M_{POL} are given by eq. (8) and eq. (9), respectively. Carrying out the matrix multiplication in eq. (29) yields

$${M}_{POL} ( θ ) = ( \begin{matrix}1 & cos 2 θ & sin 2 θ & 0 \\ cos 2 θ & {cos}^{2} 2 θ & cos 2 θ sin 2 θ & 0 \\ sin 2 θ & cos 2 θ sin 2 θ & {sin}^{2} 2 θ & 0 \\ 0 & 0 & 0 & 0\end{matrix} ) \qquad ( 30 )$$

Finally, multiplying the Stokes vector of the input beam, eq. (20), with eq. (30) yields

$${S}^{′} = \frac{1}{2} ( {S}_{0} + {S}_{1} cos 2 θ + {S}_{2} sin 2 θ ) ( \begin{matrix}1 \\ cos 2 θ \\ sin 2 θ \\ 0\end{matrix} ) \qquad ( 31 )$$

Eq. (31) shows that regardless of the state of polarization of the incident beam, the Stokes vector of the output beam will always be on the equator for the Poincare' Sphere or on the prime meridian of the Observable Polarization Sphere. Because we choose the Observable Polarization Sphere to be the “primary” polarization sphere and the Poincare' Sphere as the “secondary” polarization sphere, the Stokes vector of the output beam will always be located on the prime meridian of the Observable Polarization Sphere; this behavior is also preserved on the Hybrid Polarization Sphere. Furthermore, if there is no physical rotation the output beam will be linearly horizontal polarized, that is, it will be located at the north pole of the Observable Polarization Sphere and the Hybrid Polarization Sphere.

The Hybrid Polarization Sphere

On the Hybrid Polarization Sphere the alpha-delta form of the Stokes vector given by eq. (20) is used to describe the coordinates. The Hybrid Polarization Sphere is constructed in the following way. First, we begin with the Observable Polarization Sphere in the orientation as shown in FIG. 4. Then the Poincare' Sphere shown in FIG. 3 is rotated clockwise through 90° and superposed onto the plot of the Observable Polarization Sphere. The resulting plot, the Hybrid Polarization Sphere, is shown in FIG. 5. On the Hybrid Polarization Sphere the longitudinal great circles represent the angle α. The latitudinal great circles, on the other hand, represent the ellipticity angle χ. Similarly, the longitudinal small circles represents the rotation angle ψ. Lastly, the latitudinal small circles represent the phase shift δ. Physical rotations are described by the rotation angle θ and physical phase shifts are described by the phase angle φ. Physical rotations and physical phase shifts take place only on the small circles. Therefore, on the Hybrid Polarization Sphere all movements due to physical rotation and phase shifting take place only on the longitudinal and latitudinal small circles. Furthermore, clockwise rotation of the polarization ellipse, described by a positive rotation angle θ, corresponds to an upward motion along the small vertical (longitudinal) rotation circle. A counterclockwise rotation of the polarization ellipse is described by the negative rotation angle θ and corresponds to a downward motion along the small vertical (longitudinal) rotation circle. Similarly, moving along the small horizontal (latitudinal) circle to the right from the prime meridian corresponds to a positive phase shift of the angle φ. Movement from the prime meridian to the left corresponds to a negative phase shift of the angle φ.

We now show that the form of the Stokes vectors for linearly polarized light are identical on both the Poincare' Sphere and the Observable Polarization Sphere. On the Poincare' Sphere the Stokes vector is given by eq. (11),

$$S = ( \begin{matrix}{S}_{0} \\ {S}_{1} \\ {S}_{2} \\ {S}_{3}\end{matrix} ) = ( \begin{matrix}1 \\ cos 2 χ cos 2 ψ \\ cos 2 χ sin 2 ψ \\ sin 2 χ\end{matrix} ) 0 \leq ψ \leq π , - \frac{π}{4} \leq χ \leq \frac{π}{4} \qquad ( 11 )$$

The Stokes vector for the Observable Polarization Sphere, on the other hand, is given by

$$S = ( \begin{matrix}{S}_{0} \\ {S}_{1} \\ {S}_{2} \\ {S}_{3}\end{matrix} ) = ( \begin{matrix}1 \\ cos 2 α \\ sin 2 α cos δ \\ sin 2 α sin δ\end{matrix} ) 0 \leq α \leq π / 2 , 0 \leq δ < 2 π \qquad ( 20 )$$

In general, the vectors are obviously very different from each other. However, on the prime meridian of the Hybrid Polarization Sphere both Stokes vectors reduce to the Stokes vectors for linearly polarized light, namely,

$$\begin{matrix}{S}_{LP} = ( \begin{matrix}{S}_{0} \\ {S}_{1} \\ {S}_{2} \\ {S}_{3}\end{matrix} ) = ( \begin{matrix}1 \\ cos 2 α \\ sin 2 α \\ 0\end{matrix} ) \\ and & ( 22 ) \\ {S}_{LP} = ( \begin{matrix}{S}_{0} \\ {S}_{1} \\ {S}_{2} \\ {S}_{3}\end{matrix} ) = ( \begin{matrix}1 \\ cos 2 ψ \\ sin 2 ψ \\ 0\end{matrix} ) & ( 13 )\end{matrix}$$

Thus, the forms of these vectors are identical and so on both the Poincare' Sphere and the Observable Polarization Sphere we have a complete one-to-one correspondence between α and δ and ψ and χ for all linear polarization states. This means that the movements along the small circles are identical on both spheres and on the Hybrid Polarization Sphere.

In order to describe the effects of rotation of waveplates, the equation that is to be used is

M_{WP}(φ,θ)=M_{ROT}(−θ)·M_{WP}(φ)·M_{ROT}(θ) (32)

where the Mueller matrix M_{WP}(φ) is given by eq. (7) and M_{ROT}(θ) is given by eq. (8). Similarly, the equation for the rotation of an ideal linear polarizer is described by

M_{POL}(θ)=M_{ROT}(−θ)·M_{POL}·M_{ROT}(θ) (33)

where M_{POL} is given by eq. (9). The equations for the non-rotating polarizing elements, that is, where there is only phase shifting and attenuation, are given by eq. (7) and eq. (9), respectively.

The form of eq. (32) and eq. (33) indicate the manner in which the Stokes vector that propagates through a polarizing element is generated from an incident Stokes vector. In both cases the input and output Stokes vectors are related by the equations

S′=M_{ROT}(−θ)·M_{WP}(φ)·M_{ROT}(θ)·S (34)

S′=M_{ROT}(−θ)·M_{POL}·M_{ROT}(θ)·S (35)

The two equations, eq. (34) and eq. (35), describe the steps to be taken in moving on the Hybrid Polarization Sphere.

We now consider the motion of rotation and phase shifting along the longitudinal and latitudinal small circles, respectively, on the Hybrid polarization sphere.

Rotation

An incident beam is represented by a Stokes vector S. The Stokes vector is located at the coordinates α and δ. The Mueller matrix for rotation is given by eq. (8)

$${M}_{ROT} ( θ ) = ( \begin{matrix}1 & 0 & 0 & 0 \\ 0 & cos 2 θ & sin 2 θ & 0 \\ 0 & - sin 2 θ & cos 2 θ & 0 \\ 0 & 0 & 0 & 1\end{matrix} ) \qquad ( 8 )$$

The input Stokes vector is first rotated in a positive θ direction according to the equation,

S′=M_{ROT}(θ)·S (36)

where S′ indicates that this is the Stokes vector of the beam emerging from the operation of rotation. A clockwise rotation on the Hybrid Polarization Sphere is carried out by moving upwards from S along the vertical (longitudinal) small circle through the angle θ to S¹. Similarly, for a counter-clockwise rotation there is a downward rotation along the vertical (longitudinal) small circle through the angle θ to S¹.

In FIG. 6, this rotation is seen to occur along the vertical longitudinal small circles on the Hybrid Polarization Sphere. For the sake of clarity, the latitudinal great circle is suppressed.

In FIG. 7, a flow chart is presented that describes rotation in terms of the mathematical operations along with the corresponding description of the rotational movement carried out on the Hybrid Polarization Sphere.

Phase Shifting

An incident beam is again represented by a Stokes vector S. The Stokes vector is located at the coordinates α and δ. The Mueller matrix for phase shifting is given by eq. (7)

$${M}_{WP} ( φ ) = ( \begin{matrix}1 & 0 & 0 & 0 \\ 0 & 1 & 0 & 0 \\ 0 & 0 & cos φ & - sin φ \\ 0 & 0 & sin φ & cos φ\end{matrix} ) \qquad ( 7 )$$

The input Stokes vector moves along the horizontal (latitudinal) small circle in a positive direction according to the equation,

S′=M_{WP}(φ)·S (37)

through an angle φ to S′.

In FIG. 8 the phase shifting is shown taking place on the horizontal small circles on the Hybrid Polarization Sphere. Again, for the sake of clarity, the longitudinal small circles are suppressed. In FIG. 9, another flow chart is presented that describes phase shifting in terms of the mathematical operations along with the corresponding description of the rotational movement on the Hybrid Polarization Sphere.

By these two simple motions for rotation and phase shifting, all polarization states can be found and described (determined) on the Hybrid Polarization Sphere.

The Rotated Waveplate

We now consider the movement of an input Stokes vector through a rotated waveplate, eq. (34),

S′=M_{WP}(φ,θ)·S=M_{ROT}(−θ)·M_{WP}(φ)·M_{ROT}(θ)·S (38)

According to eq. (38) the input Stokes vector is first rotated in a positive θ direction according to the equation,

S′=M_{ROT}(θ)·S (39)

where S¹ indicates that this is the (first) Stokes vector of the beam emerging from the operation of rotation. A clockwise rotation on the Hybrid Polarization Sphere is carried out by moving upwards from S along the vertical (longitudinal) small circle through the angle θ to S¹. Similarly, for a counter-clockwise rotation there is a downward rotation along the vertical (longitudinal) small circle through the angle θ to S¹.

Next, the beam S¹ propagates through the waveplate and undergoes a positive phase shift φ. The Stokes vector that emerges from the waveplate is then

S²=M_{WP}(φ)·S¹ (40)

On the Hybrid Polarization Sphere the point S¹ moves to the right along the horizontal small circle latitude line through a phase shift angle φ to the point S². Finally, S² undergoes a negative rotation through an angle θ and the Stokes vector of the beam becomes

S³=M_{ROT}(−θ)·S² (41)

This final rotation operation is accomplished by moving downward along the vertical small circle rotation line through an angle θ, which corresponds to −θ.

The behavior of the rotated waveplate is shown in FIG. 10 which is a flow chart showing the mathematical operations on the left side and the corresponding operations on the right side on the Hybrid Polarization Sphere.

The Rotated Linear Horizontal Polarizer

We now consider the behavior of a rotated ideal linear polarizer on the polarization state of an incident beam.

An incident beam is again represented by a Stokes vector S. According to eq. (35) this Stokes vector is first rotated in a positive θ direction according to the equation,

S¹=M_{ROT}(θ)·S (42)

where S¹ indicates that this is the (first) Stokes vector of the beam emerging from the operation of rotation. This rotation is shown on the Hybrid Polarization Sphere by again moving upwards from S along the vertical small circle (rotation) through the angle θ to S¹. Next, the beam S¹ propagates through the linear polarizer. The Stokes vector of the beam that emerges from the linear polarizer is then

S²=M_{POL}·S¹ (43)

We saw earlier that the effect of the linear polarizer is that regardless of the polarization state of the incident beam, the beam that emerges from the linear polarizer is always linearly polarized. Thus, on the Hybrid Polarization Sphere the point S¹ moves directly to the point on the sphere that represents linearly horizontal polarized light, which is the north pole of the Hybrid Polarization Sphere. In fact, we see that the first rotation described by eq. (36) has no effect on the polarization state of the incident beam S, whatsoever, so we can move immediately to the north pole on the sphere to the point S². Finally, S² undergoes a negative rotation through an angle θ and the Stokes vector of the beam becomes

S³=M_{ROT}(−θ)·S² (44)

This final rotation operation is accomplished by moving downward on the vertical small circle on the Hybrid Polarization Sphere line through an angle θ.

FIG. 11 shows a flow chart that describes the mathematical operations and the corresponding movement for the rotation of a linear horizontal polarizer on the Hybrid Polarization Sphere.

Finally, a cascade of polarizing elements can easily be treated on the Hybrid Polarization Sphere. A flow chart of this process is shown in FIG. 12.

Examples of the Propagation of an Input Beam through a Rotator, a Rotated Linear Polarizer, and a Rotated Waveplate on the Hybrid Polarization Sphere

In order to make the preceding analysis concrete we consider specific examples of the propagation of a polarized beam through 1) a rotator, 2) a rotated linear horizontal polarizer, and 3) a rotated waveplate of arbitrary phase. In FIG. 13 the transformation equations that should be used to transform the Stokes parameters to the α, δ form or to the Cartesian form is shown. For the sake of simplicity we consider the same input Stokes vector for each of these polarizer examples and place the incident beam location at α=π/4 and δ=11π/6. Using this coordinate pair the Stokes vector is then seen from eq. (20) to be

$$S = ( \begin{matrix}1 \\ cos 2 α \\ sin 2 α cos δ \\ sin 2 αsin δ\end{matrix} ) = ( \begin{matrix}1 \\ 0 \\ \frac{\sqrt{3}}{2} \\ - \frac{1}{2}\end{matrix} ) \qquad ( 45 )$$

Eq. (42) describes a point that is located on the equator (2α=90°) and 30° to the left of the prime meridian (δ=−30°). This point is shown as A on the Hybrid Polarization Sphere in FIG. 14.

1) Optical Propagation through a Rotator on the Hybrid Polarization Sphere

Consider now that the input beam is rotated in a positive direction by means of a rotator. The output beam is then found from eq. (39) to be

S′=M_{ROT}(θ)·S (46)

The rotator is rotated, say, clockwise through an angle of θ=15°. According to eq. (8) the Mueller matrix for rotation then becomes

$${M}_{ROT} ( θ = {15}^{°} ) = ( \begin{matrix}1 & 0 & 0 & 0 \\ 0 & \frac{\sqrt{3}}{2} & \frac{1}{2} & 0 \\ 0 & - \frac{1}{2} & \frac{\sqrt{3}}{2} & 0 \\ 0 & 0 & 0 & 1\end{matrix} ) \qquad ( 47 )$$

Using eq. (42) and eq. (44) the Stokes vector of the output beam is then calculated to be

$${S}^{′} = ( \begin{matrix}1 \\ \frac{\sqrt{3}}{4} \\ \frac{3}{4} \\ - \frac{1}{2}\end{matrix} ) \qquad ( 45 )$$

We immediately find that the calculated values of α′ and δ′ are

$$\begin{matrix}{α}^{′} = \frac{1}{2} arccos ( \frac{\sqrt{3}}{4} ) = {32.18}^{°} & ( 46 a ) \\ {δ}^{′} = - arctan ( \frac{2}{3} ) = - {33.68}^{°} & ( 46 b )\end{matrix}$$

Inspecting the Hybrid Polarization Sphere in FIG. 14 we see that we move up from the point A on the equator along the vertical small circle through 30° to point B. Each point on the small circle corresponds to 7.5° so we move up to the 4^{th} tic mark on the small vertical circle. We see that this mark is slightly below the 30° latitudinal circle. In terms of the angle α, (actually 2α) we observe that the angle measured down from the north pole of the sphere is 2α′=64.36°. We move directly down the prime meridian to 2α′=64.36° and then move to the left along the latitudinal small circle to the point of intersection with the vertical small circle. We see that the point of intersection corresponds to the calculated values of 2α′ and δ′. Thus, we see that by merely moving along the small vertical circle upward or downward we arrive at the correct values of 2α′ and δ′ for the Stokes vector of the output beam.

2) Optical Propagation through a Rotated Linear Horizontal Polarizer on the Hybrid Polarization Sphere

The Stokes vector of a beam that emerges from an ideal linear polarizer rotated through an angle θ is immediately determined from the equation,

$${S}^{′} = \frac{1}{2} ( {S}_{0} + {S}_{1} cos 2 θ + {S}_{2} sin 2 θ ) ( \begin{matrix}1 \\ cos 2 θ \\ sin 2 θ \\ 0\end{matrix} ) \qquad ( 31 )$$

The initial polarization state is given by the Stokes vector, eq. (42),

$$S = ( \begin{matrix}1 \\ cos 2 α \\ sin 2 α cos δ \\ sin 2 αsin δ\end{matrix} ) = ( \begin{matrix}1 \\ 0 \\ \frac{\sqrt{3}}{2} \\ - \frac{1}{2}\end{matrix} ) \qquad ( 42 )$$

We immediately see that these parameters, eq. (42), appear in the factor before the Stokes vector in eq. (31). This shows that the polarization state of the input beam does not affect the polarization state of the output beam. With a linear polarizer, the Stokes parameters of the input beam only affect the intensity of the output beam and not its polarization; the output beam always appears on the prime meridian. For a rotation of say θ=15°. eq. (31) shows that the beam is rotated through twice this angle measured from the equation so 2θ=30°. The Stokes vector of the output beam according to eq. (31) is then

$${S}^{′} = ( \begin{matrix}1 \\ cos ( \frac{π}{3} ) \\ sin ( \frac{π}{3} ) \\ 0\end{matrix} ) = ( \begin{matrix}1 \\ \frac{1}{2} \\ \frac{\sqrt{3}}{2} \\ 0\end{matrix} ) \qquad ( 47 )$$

We then find that

$${α}^{′} = \frac{1}{2} arccos ( \frac{1}{2} ) = {30}^{°} \qquad ( 48 )$$

and 2α′=60°. On the Hybrid Polarization Sphere, a physical rotation of 30° corresponds to 2α=60° and so we count down from the north pole by this amount. This is shown in FIG. 15. Because of the non-uniform spacing between latitude lines, however, it is easier to count (up) from the origin O on the equator using the complementary angle of 30° to the fourth point on the prime meridian.

3) Optical Propagation through a Rotated Waveplate on the Hybrid Polarization Sphere

The third and final type of polarizer is the rotated variable/fixed phase waveplate. We now consider its behavior on an input polarized beam on the Hybrid Polarization Sphere. We again begin with an input beam characterized by a Stokes vector

$$S = ( \begin{matrix}1 \\ 0 \\ \frac{\sqrt{3}}{2} \\ - \frac{1}{2}\end{matrix} ) \qquad ( 49 )$$

We consider that we now have a waveplate with a phase shift of, say, 60° and rotated through an angle of 15°. For these conditions the Mueller matrix for the rotated waveplate, eq. (34), is found to be

$${M}_{WPROT} ( φ = {60}^{°} , θ = {15}^{°} ) = ( \begin{matrix}1 & 0 & 0 & 0 \\ 0 & \frac{7}{8} & \frac{\sqrt{3}}{8} & \frac{\sqrt{3}}{4} \\ 0 & \frac{\sqrt{3}}{8} & \frac{5}{8} & - \frac{3}{4} \\ 0 & - \frac{\sqrt{3}}{4} & \frac{3}{4} & \frac{1}{2}\end{matrix} ) \qquad ( 50 )$$

Multiplying eq. (50) by the Stokes vector of the input beam, eq. (49), the Stokes vector of the output beam is found to be

$${S}^{′} = ( \begin{matrix}1 \\ \frac{3}{16} - \frac{\sqrt{3}}{8} \\ \frac{5 \sqrt{3}}{16} + \frac{3}{8} \\ \frac{3 \sqrt{3}}{8} - \frac{1}{4}\end{matrix} ) \qquad ( 51 )$$

The angles 2α′ and δ′ are then found to be

$$\begin{matrix}2 {α}^{′} = arccos ( \frac{3}{16} - \frac{\sqrt{3}}{8} ) = {91.66}^{∘} & ( 52 a ) \\ δ = arctan ( \frac{\frac{3 \sqrt{3}}{8} - \frac{1}{4}}{\frac{5 \sqrt{3}}{16} + \frac{3}{8}} ) = {23.56}^{∘} & ( 52 b )\end{matrix}$$

We now show that this value is obtained by moving on the Hybrid Polarization Sphere. The movement is shown in FIG. 16.

The Stokes vector for the incident beam is again given by

$${S}_{A} = ( \begin{matrix}1 \\ 0 \\ \frac{\sqrt{3}}{2} \\ - \frac{1}{2}\end{matrix} ) \qquad ( 42 )$$

The subscript “A” is used to indicate that this is the first Stokes vector in the polarization train. The Stokes vector S_{A} now undergoes a clockwise rotation of θ=15°. According to eq. (32) a positive rotation is made by moving up the vertical small circle to the fourth point; this point corresponds to S_{B}. The Stokes vector is calculated to be

$${S}_{B} = ( \begin{matrix}1 \\ \frac{\sqrt{3}}{4} \\ \frac{3}{4} \\ - \frac{1}{2}\end{matrix} ) \qquad ( 53 )$$

The angles 2α′ and δ′ are then found to be

$$\begin{matrix}2 {α}^{′} = arccos ( \frac{\sqrt{3}}{4} ) = {64.33}^{∘} & ( 54 a ) \\ {δ}^{′} = - arctan ( \frac{2}{3} ) = - {33.68}^{∘} & ( 54 b )\end{matrix}$$

Inspecting FIG. 16 we see that these values correspond to the observed S_{B}. Next, S_{B} undergoes a phase shift of 60°. The phase shift is shown by moving S_{B} along a latitude line through 60° to the longitudinal great circle slight to the left of the 30° longitudinal great circle line to the point S_{C}. The Stokes vector is calculated to be

$${S}_{C} = ( \begin{matrix}1 \\ \frac{\sqrt{3}}{4} \\ \frac{3}{8} + \frac{\sqrt{3}}{4} \\ - \frac{1}{4} + \frac{3 \sqrt{3}}{8}\end{matrix} ) \qquad ( 55 )$$

The angles 2α′ and δ′ are then found to be

$$\begin{matrix}2 {α}^{′} = arccos ( \frac{\sqrt{3}}{4} ) = {64.33}^{∘} & ( 56 a ) \\ {δ}^{′} = - arctan ( \frac{- \frac{1}{4} + \frac{3 \sqrt{3}}{8}}{\frac{3}{8} + \frac{\sqrt{3}}{4}} ) = {26.30}^{∘} & ( 56 b )\end{matrix}$$

We see that we have indeed moved along a latitude line characterized by the above value of 2α′. Furthermore, we also note that the total phase shift between S_{C} and S_{B} is

φ_{CB}=26.30°−(−33.68°)=59.98° (57)

which is the value of the expected phase shift. Finally, according to eq. (42) a negative rotation is required corresponding to θ=15°. We see that S_{C} is slightly below 2α′=60°. Counting down from S_{C} through four points on the small vertical circle we arrive at S_{D}. We see that this point is slightly below the equator. The Stokes vector, S_{D}, is calculated to be

$${S}_{D} = ( \begin{matrix}1 \\ \frac{3}{16} - \frac{\sqrt{3}}{8} \\ \frac{\sqrt{3}}{8} + \frac{\sqrt{3}}{2} ( \frac{3}{8} + \frac{\sqrt{3}}{4} ) \\ - \frac{1}{4} + \frac{3 \sqrt{3}}{8}\end{matrix} ) \qquad ( 58 )$$

The angles 2α′ and δ′ are then found to be

$$2 {α}^{′} = arccos ( \frac{3}{16} - \frac{\sqrt{3}}{8} ) = {91.66}^{∘} \qquad ( 59 a )$$

$${δ}^{′} = - arctan ( \frac{- \frac{1}{4} + \frac{3 \sqrt{3}}{8}}{\frac{\sqrt{3}}{8} + \frac{\sqrt{3}}{2} ( \frac{3}{8} + \frac{\sqrt{3}}{4} )} ) = {23.56}^{∘} \qquad ( 59 b )$$

Inspecting FIG. 16 we see the exact calculation shows that S_{D} is slightly below the equator (eq. (59a)). Furthermore, counting from the prime meridian along the equator we also see that S_{D} is slightly to the right of the 22.5° point, the exact value being given by eq. (59b). Finally, we see that values given in eq. (59) are exactly those obtained at the beginning of this section so that we have complete agreement.

Thus, we have shown that by moving along vertical and horizontal small circles on the Hybrid Polarization Sphere we can describe and calculate visually the Stokes vectors that propagate through rotators, linear polarizers, and waveplates. While we have restricted the foregoing analysis to the treatment of just each type of polarizing element, we see that the analysis can be used to deal with any arbitrary number of polarizing elements. Thus, we can calculate visually the Stokes vector of the optical polarization train at any point without having to do the mathematical (matrix algebra) calculations. The calculations have been included in the above examples to confirm that we have indeed arrived the correct points.

### DETAILED DESCRIPTION OF THE PREFERRED EMBODIMENT

This invention involves the use of a geometric form: a four-pole sphere. The simplest physical embodiment of this invention uses a sphere or globe that can be constructed of plastic or other rigid material, similar to that done by H. G. Jerrard for the Poincare' Sphere (Jerrard, 1954). On this four-pole sphere, latitudes and longitudes for the Poincare' Sphere are superposed onto those of the Observable Polarization Sphere in the relative orientation described earlier. Distinctive graphical treatments for the two coordinate systems (e.g., distinct colors and labels) unambiguously show the sphere's orientation. As the sphere may be used hand-held, mounting it in a frame or gimbal would be optional. Using the device, the SOP transformation caused by any sequence of waveplates, polarizers, and rotators may be estimated by visual interpolation, without requiring solution of trigonometric equations or matrix algebra or the use of any other external calculation aid (e.g., calculator, computer, protractor, or slide rule). This would enable practitioners to calculate visually the transformation of the SOP by a sequence of polarizing elements.

A variant of the first embodiment would be a flat map using two or more orthographic projections of the HPS. FIG. 5 shows one such projection: a “front view” centered on the intersection of the OPS Prime Meridian and Equator, or, in Stokes terms, looking down the positive S₂ axis toward the origin. Placing that front view side-by-side with the corresponding “back view” of the occluded hemisphere yields a complete map of the sphere that can readily be used for the same computations as the globe. One advantage of the map-based embodiment is the ease of scaling up a map relative to a globe. A larger map means more latitude and longitude lines, and hence greater accuracy and less demand on visual interpolation. Another advantage of this particular map projection is that rotations and phase shifts correspond to horizontal and vertical straight lines on a plane, which makes them easier to draw. A disadvantage of the map approach is that rotations and phase shifts that span both hemispheres require the user to be able to locate the continuation of a horizontal or vertical line when it crosses hemispheres.

The preferred embodiment of the invention, however, is as a computer display for polarization information. The block diagram in FIG. 17 shows the four interconnected functions of this embodiment.

The box labeled Plot Manager manages both static and dynamic data plots upon the hybrid polarization sphere. It plots two different kinds of graphic elements, as described in the summary of this invention:

loci of points, where each point represents a distinct SOP

directed arc segments representing angular displacements between two SOP

Plot Manager is also capable of creating animations of dynamic system behavior, as previously described in the summary.

The box labeled Sphere Renderer depicts the hybrid polarization sphere upon the display device. This includes three parts:

the outline and form of the sphere

latitude and longitude lines for both the Poincare' and OPS coordinate systems

data points and figures plotted upon the sphere's surface, as provided by the Plot Manager

This renderer contains the following capabilities, which are common in computerized displays of geometric forms:

A method to position the displayed HPS in any orientation under interactive or program control

A method to scale the size of the HPS under interactive or program control (“zoom”)

A method to identify the location of any specific point or feature on the sphere's surface using either Poincare' or OPS coordinates.

Some variant methods for reducing visual clutter when displaying four-pole spheres also apply to our preferred embodiment:

The display of one or the other of the two coordinate systems may be temporarily suppressed

Either the latitude or longitude lines of either or both coordinate systems may be temporarily suppressed

The resolution of the latitude and longitude lines in both coordinate systems may be changed, especially but not exclusively in conjunction with scaling.

The four-pole sphere may be rendered as two mutually orthogonal two-pole spheres, one Poincare' and one OPS, displayed side-by-side and moving in tandem, and upon which identical information is plotted

None of these techniques alters or sidesteps the fundamental relationship between the two coordinate systems that is the basis of the invention. They merely filter the visual presentation of this relationship.

The boxes labeled Display Device and Display Controller contain no technology specific to this application, but are necessary for its functioning. Display Device represents a physical device for displaying graphical information to a human, either in perspective on a two-dimensional plane, stereographically or holographically in three dimensions, or as multiple orthographic plots. Display Controller stores an electronic representation of an image to be displayed and provides the electrical signals required to operate and to refresh the display device. It provides a set of well-defined interfaces so that rendering engines may update the image being displayed in real time, and thus achieve animation capabilities.

In a reference implementation of the preferred embodiment created to support this patent application, the following realizations were used:

Plot Manager: a computer program

Hybrid Sphere Renderer: a computer program using the OpenGL graphics libraries

Display Controller: a CRT display controller card in a personal computer, together with its driver software

Display Device: a CRT monitor for a personal computer

However, this choice of realization is not integral to the invention; it merely demonstrates feasibility of satisfactory performance.

### BRIEF DESCRIPTION OF THE DRAWINGS

FIG. 1. The spherical coordinates of the Poincare' Sphere.

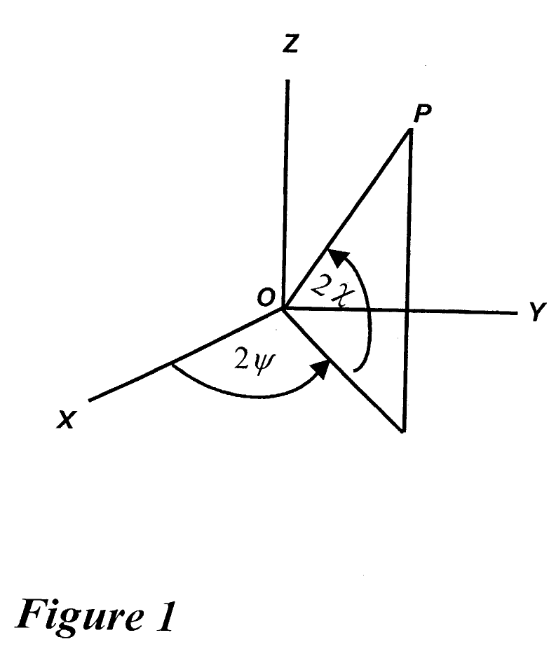

FIG. 2. The degenerate polarization states plotted on the Poincare' Sphere.

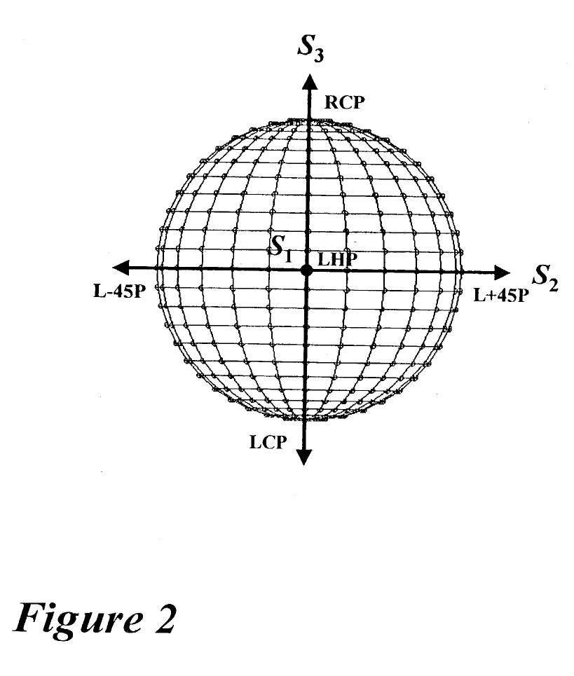

FIG. 3. The spherical coordinates of the Observable Polarization Sphere.

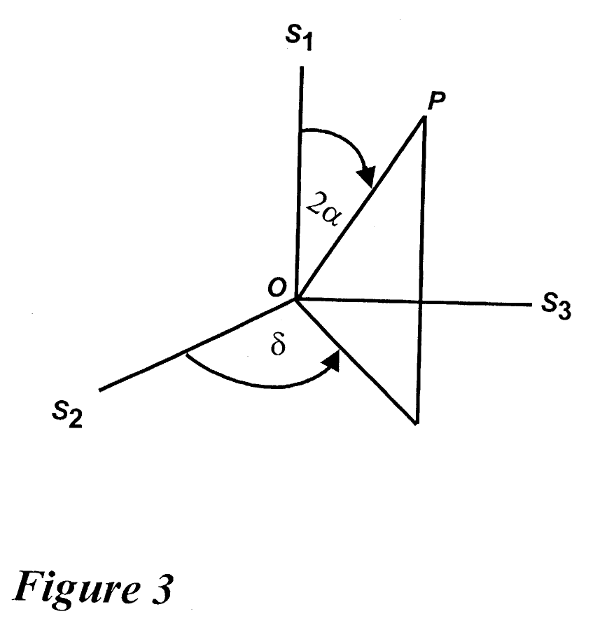

FIG. 4. The degenerate polarization states plotted on the Observable Polarization Sphere.

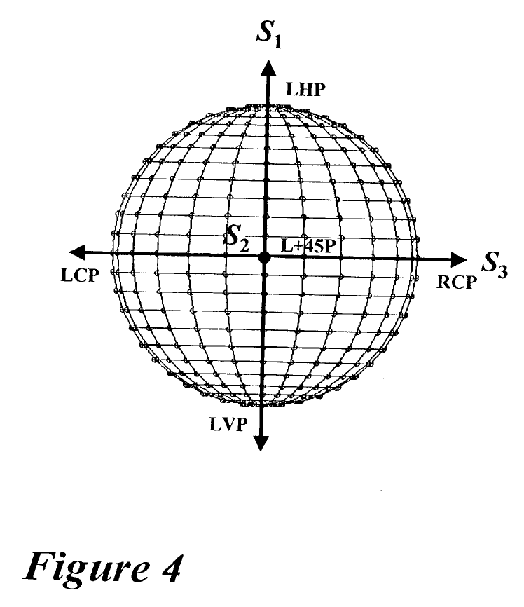

FIG. 5. The Hybrid Polarization Sphere showing the latitudinal great circles and the longitudinal small circles. The orientation is identical to the Observable Polarization Sphere.

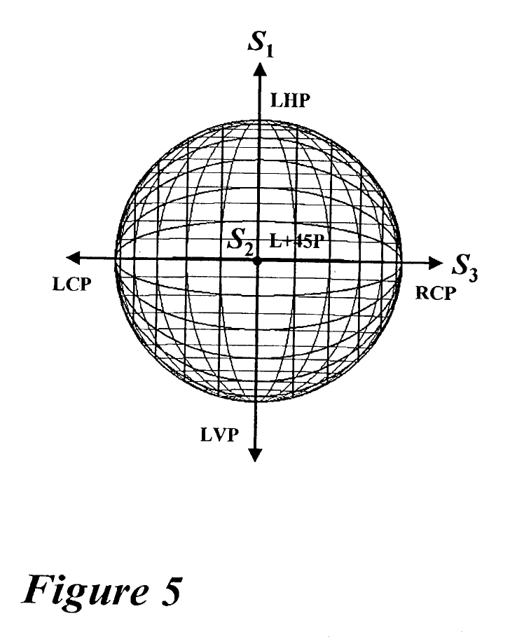

FIG. 6. Rotation on the Hybrid Polarization Sphere.

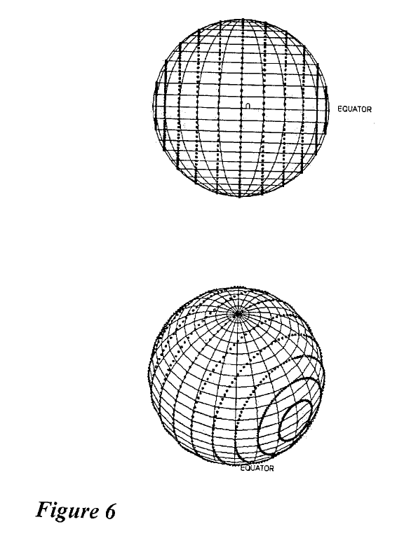

FIG. 7. Flow chart to describe Rotation on the Hybrid Polarization Sphere.

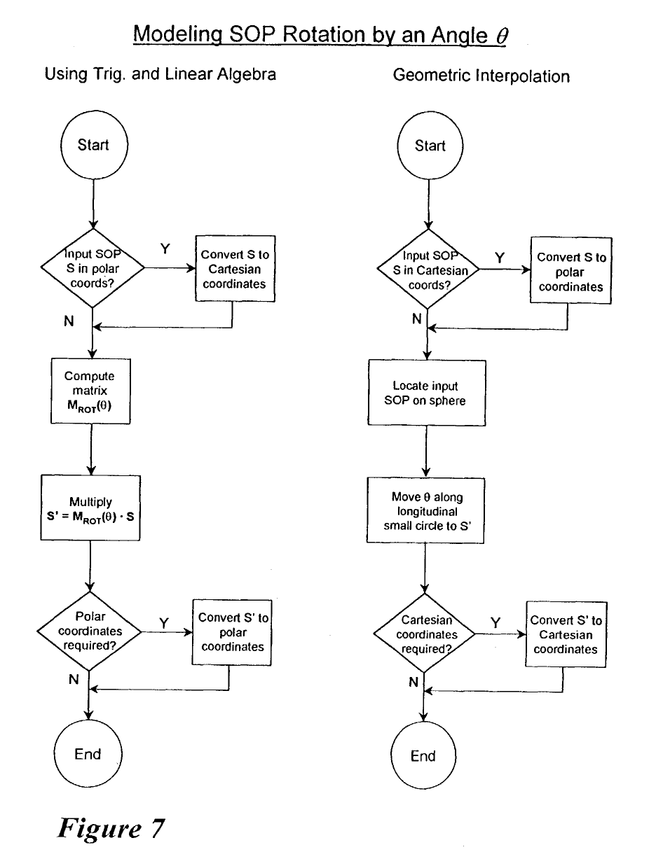

FIG. 8. Phase shifting on the Hybrid Polarization Sphere.

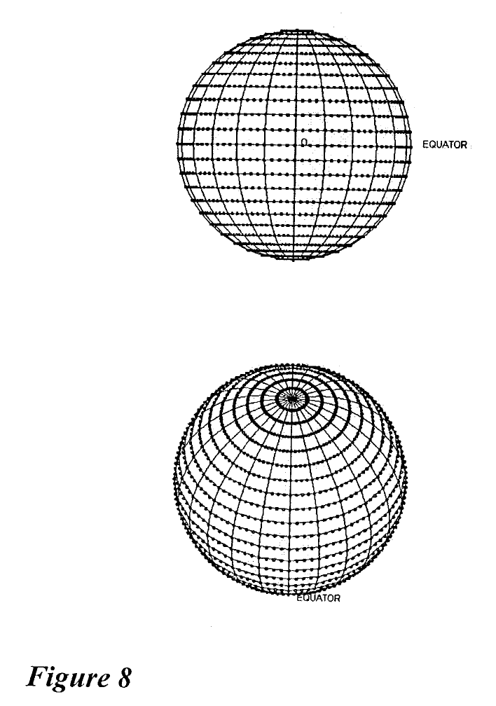

FIG. 9. Flow chart to describe Phase Shifting on the Hybrid Polarization Sphere.

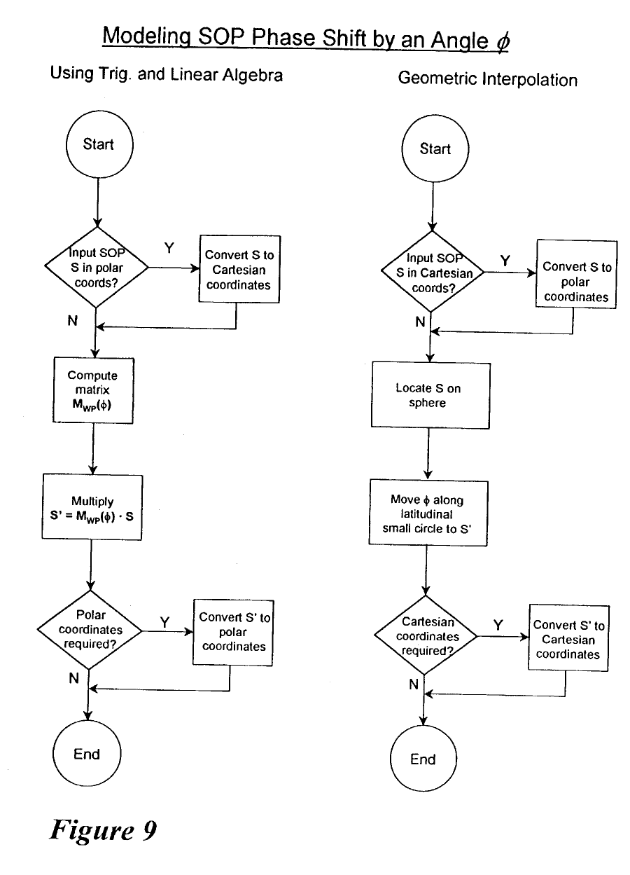

FIG. 10. Flow chart to describe the rotation of a phase shifter (waveplate) on the Hybrid Polarization Sphere.

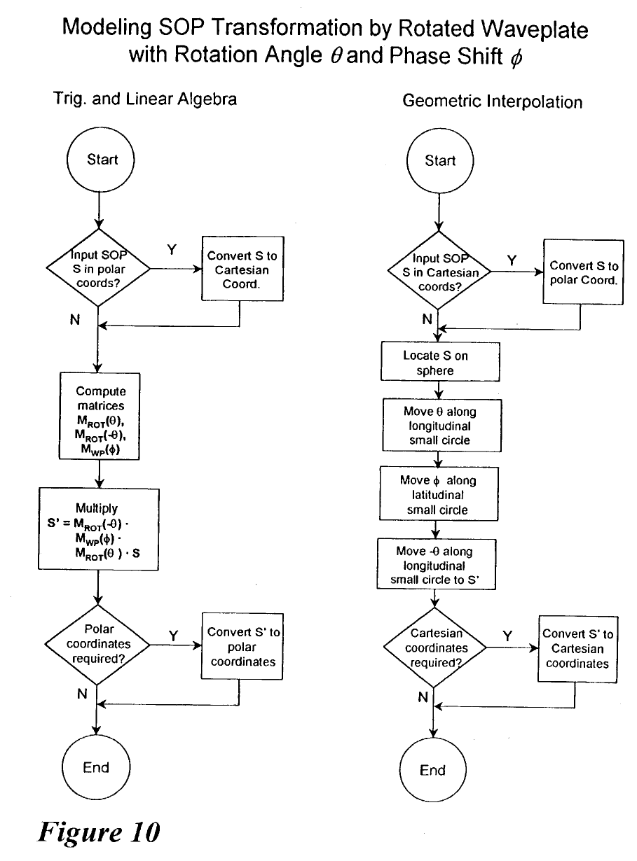

FIG. 11. Flow chart for the rotation of a linear horizontal polarizer (attenuation) on the Hybrid Polarization Sphere.

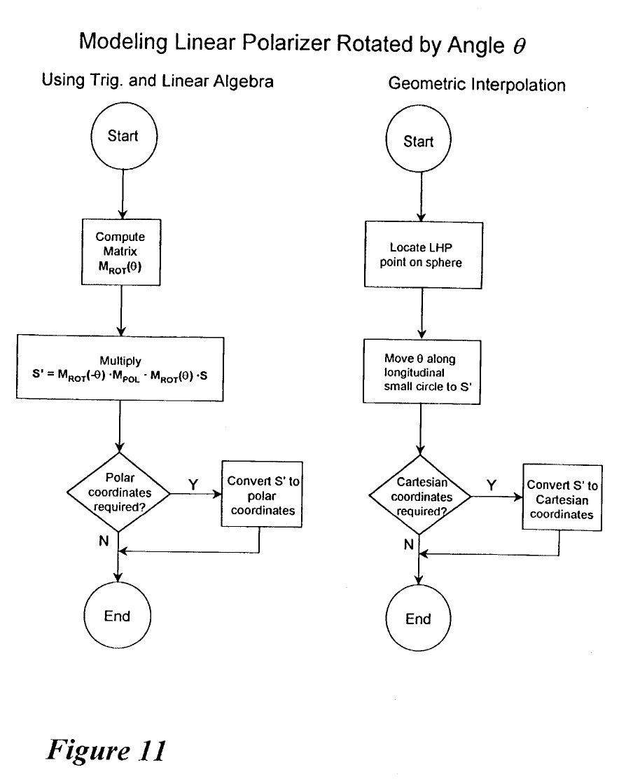

FIG. 12. Flow chart for the visualization and calculation of a cascade of N polarizing elements on the Hybrid Polarization Sphere.

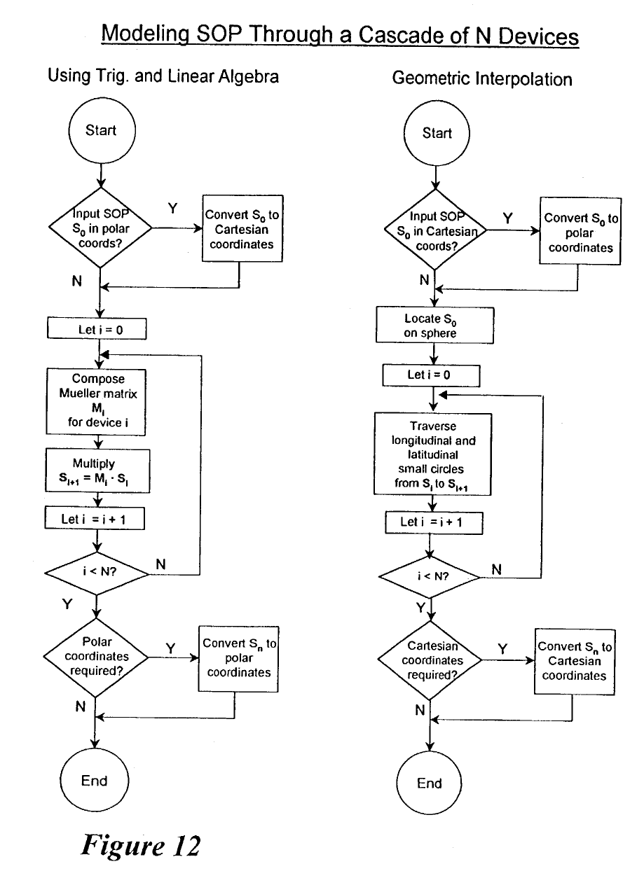

FIG. 13. Conversion Equations on the Hybrid Polarization Sphere.

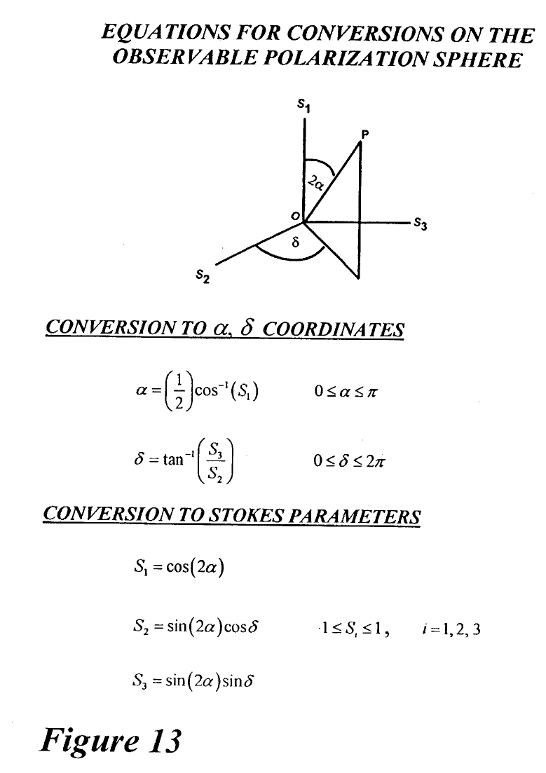

FIG. 14. Rotation on the Hybrid Polarization Sphere.

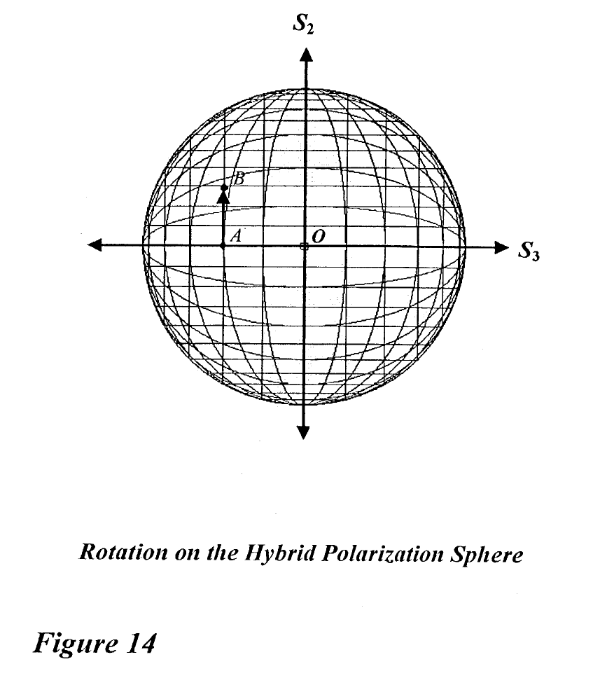

FIG. 15. Rotation of a Linear Horizontal Polarizer on the Hybrid Polarization Sphere.

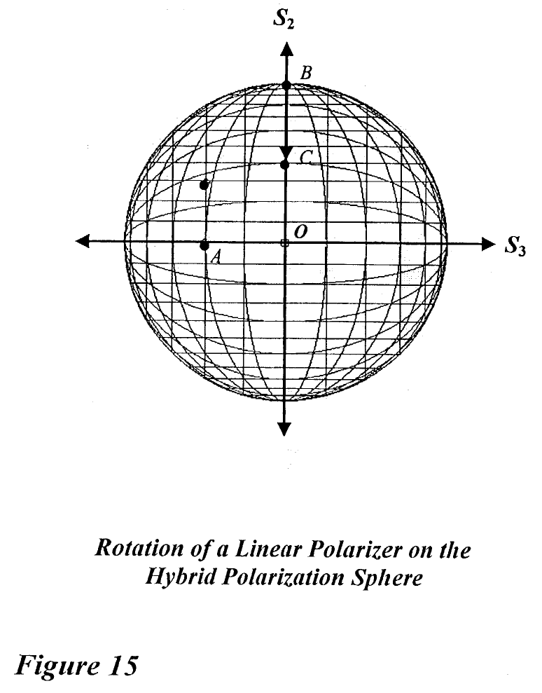

FIG. 16. Phase Shifting with Rotation on the Hybrid Polarization Sphere.

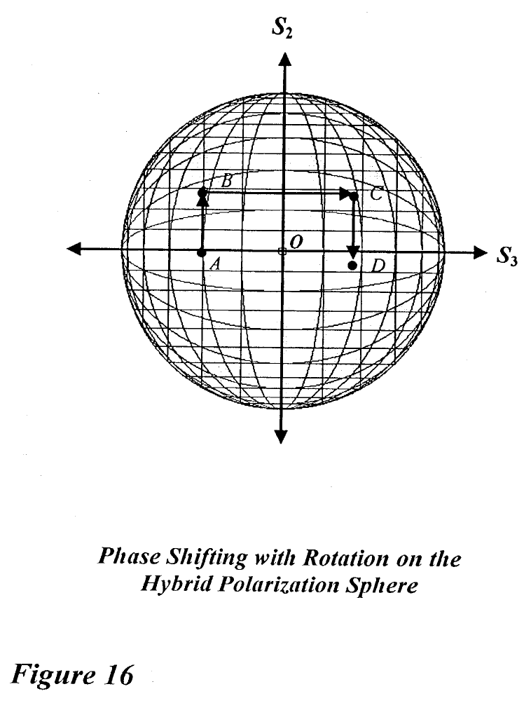

FIG. 17. Block Diagram of the Preferred Embodiment.

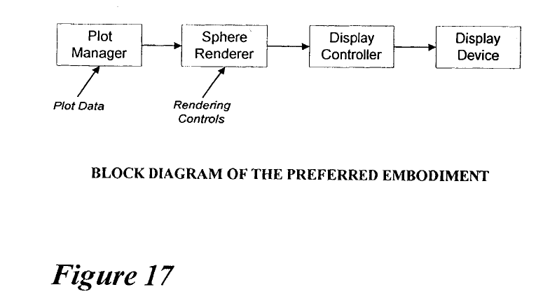

In Ken K. Tedjojuwono, William W. Hunter Jr., and Stewart L. Ocheltree, “Planar Poincare Chart: a planar graphic representation of the state of light polarization,” Applied Optics, 28 (1989) 1 July, no. 13, pp. 2614-2622 a planar presentation of the Poincare' sphere (i.e., the polarization sphere with a polar coordinate system based on rotations about the Stokes S₃ axis) was developed, using two side-by-side hemispheric stereographic projections in equatorial view. Likewise, they showed a similar planar presentation for the polarization sphere with an alpha-delta coordinate system based on rotations about the Stokes S₁ axis, this time using polar views. The authors then superimposed these two figures to display a planar plot of the polarization sphere with both Poincare' and alpha-delta coordinate systems. This produced a classic stereographic projection of a four-pole sphere, viewed along the horizontal polar axis. This work was an important precursor of the current invention, facilitating the diagramming of polarization transformations that involve rotations of the polarization sphere about both the S₁ and S₃ axes, such as with rotated waveplates.

This work had significant limitations, however, with respect to the current invention. First, the authors considered only planar, static representations of the polarization sphere, such as paper charts; they did not discuss three-dimensional realizations using either physical spheres or dynamic computer graphics.

Second, they used two fixed hemispheric viewpoints that combined equatorial and polar plots. Their technique is especially useful for monochrome, non-interactive media, but offers less clarity than the current invention, which can vary its viewpoints dynamically while using other visual cues, such as color, to disambiguate multiple coordinate systems.

Third, the current invention is not restricted to stereographic projections, even in its static planar embodiments. While stereographic projections have some useful geometric properties, and we can display them, orthographic projections are equally useful in static embodiments, and much more useful in a simulated 3D environment.

Fourth, the earlier work considered only two specific polar coordinate systems, one based on S₃-rotation (Poincare') and the other on S₁-rotation (alpha-delta). It did not discuss other types of transformations, such as TE-TM conversion, which corresponds to rotation of the polarization sphere about the Stokes S₂ axis. The current invention is applicable to displaying and analyzing polarization transformations modeled as successive rotations of the polarization sphere about any two mutually orthogonal axes. These axes may correspond to any two of S₁, S₂, and S₃, or to none of these three. For example, polarization controllers based on liquid crystal retarders create variable linear birefringence about two mutually orthogonal axes, which may or may not correspond exactly to S₁ and S₂.

Fifth, in its computer embodiments, the current invention is not limited to displaying only two orthogonal polar coordinate systems. It may manage the display of more than two (e.g., rotations about S₁, S₂, and S₃) coordinate systems, as long as no more than two are visually emphasized at one time. This last restriction is not a limitation of our invention per se, but a concession to human visual information processing.

Finally, the current invention can display coordinate systems that deviate from strict orthogonality. This is important for analyzing devices such as liquid crystal polarization controllers, which may deviate from the orthogonal ideal by a few degrees. The current invention can vary the angle between two displayed polar coordinate systems dynamically (e.g., in order to search visually for a best fit to measured data), an impossibility with a static paper plot.

1. A new polarization sphere has been invented and constructed using only observables, which are the intensity components and phase of electromagnetic radiation.

2. The polarization sphere of claim 1 enables the visualization and control of intermediate states of polarization that propagate through polarizing elements.

3. The polarization sphere of claim 1 provides a visual interpretation of the polarization behavior of the optical beam in terms of its intensity and phase.

4. The polarization sphere of claim 1 is an analog computer since it allows one to determine the magnitude of the rotation and phase shift required to reach a final polarization state from an initial polarization state. This is done by measuring the length of the meridian (longitude) lines and the latitude lines.
